(19) United States
(12) Patent Application Publication
(10) Pub. No.: US 2010/0167907 A1
(43) Pub. Date: Jul. 1, 2010

(54) METHOD FOR MANUFACTURING TRANSPARENT POLYCRYSTALLINE ALUMINUM OXYNITRIDE

(75) Inventors: Jae Hyung Lee, Busan (KR); Bon Kyung Koo, Daegu (KR); Kyo Hun Koo, Daegu (KR); Kook Rim Lee, Gyeongsan-si (KR)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Industry-Academic Cooperation Foundation Yeungnam University, Gyeongsangbuk-do (KR)

(21) Appl. No.: 12/311,812

(22) PCT Filed: Oct. 16, 2006
(86) PCT No.: PCT/KR2006/004184

§ 371 Date: Apr. 14, 2009

(51) Int. Cl. C04B 35/58

(52) U.S. Cl. 501/96.1

(57) ABSTRACT

The present invention relates to a method of manufacturing a transparent polycrystalline aluminum oxynitride. Aluminum oxynitride manufactured by prior art methods has a great number of porosities therein and thus has low transparency. The present invention is directed to solving such a problem. In the method of manufacturing aluminum oxynitride of the present invention, a sintering additive added to a source powder includes less than 0.5 wt. % MgO. Further, the source powder is presintered at 1550° C. to 1750° C. so that a relative density becomes 95% or more and is then resintered at 1900° C. or more so that a relative density higher than that of presintering can be accomplished. According to the present invention, a cubic-phased polycrystalline aluminum oxynitride ceramic can be obtained, wherein porosities therein are nearly eliminated and its substantial transparency becomes 95% or more.

### TECHNICAL FIELD

The present invention generally relates to a method of manufacturing aluminum oxynitride ceramic, and more particularly to a method of manufacturing polycrystalline aluminum oxynitride with higher transparency.

### BACKGROUND ART

Diffusion of light in alumina (Al₂O₃) is lowered in such a manner that porosities are eliminated by an atmosphere sintering high-purity powder and grain boundaries are shortened by enlarging crystal grains. U.S. Pat. No. 3,026,210 discloses a method of producing transparent alumina by using less than 0.5 wt. % MgO or MgO within a solid solubility limit as a sintering additive in order to sinter alumina.

However, although all porosities are eliminated in fabricating alumina, crystal of alumina becomes anisotropic hexagonal-phase. Thus, there is a defect in that transparency of alumina is low since light transmitted through alumina is affected by orientations of crystal grains and diffusion of light is great at the grain boundaries. On the contrary, aluminum oxynitride (Al₍₂₊ₓ₎O₃Nₓ), which is also referred to as “ALON”, is isotropic cubic-phase while having good sinterability. This facilitates the elimination of porosities and raises its transparency through economical pressureless sintering. For this reason, many attempts have been made on manufacturing a transparent polycrystalline ceramic by using aluminum oxynitride.

U.S. Pat. No. 4,141,000 discloses a method of manufacturing transparent polycrystalline aluminum oxynitride by mixing Al₂O₃ and AlN powder at an appropriate ratio, heat-treating it for 24 hours at 1200° C. under nitrogen gas atmosphere, and pressureless sintering it at more than 1800° C.

U.S. Pat. Nos. 4,481,300 and 4,520,116 disclose a transparent polycrystalline aluminum oxynitride manufactured by adding small amounts of compound of boron (B), yttrium (Y) or lanthanum (La).

U.S. Pat. No. 4,686,070 discloses a manufacturing process using a compound of B, Y or La as a sintering additive. In such a process, Al₂O₃ powder and carbon black powder are mixed at an appropriate ratio and such mixture is calcined at about 1600° C. to become Al₂O₃ and AlN. Then, it is heat-treated at about 1800° C. to be aluminum oxynitride and it becomes a fine aluminum oxynitride powder by ball milling. Thereafter, transparent aluminum oxynitride is manufactured by molding and pressureless sintering it for 24 to 48 hours at 1900° C. to 2140° C. to become a transparent aluminum oxynitride.

Further, U.S. Pat. No. 4,720,362 discloses a manufacturing process (similar to the process of U.S. Pat. No. 4,686,070) comprising adding B and Y or compound thereof at less than 0.5 wt. % to aluminum oxynitride powder and sintering it for 20 to 100 hours at more than 1900° C.

U.S. Pat. No. 5,688,730 discloses manufacturing an aluminum oxynitride powder by reaction of mixed Al₂O₃ and AlN powder, and manufacturing a transparent aluminum oxynitride by using the same.

U.S. Pat. No. 4,983,555 discloses the manufacture of a transparent polycrystalline MgO—Al₂O₃ spinel (MgAl₂O₄) ceramic with high ultraviolet transmittance through high-temperature pressure sintering. U.S. Pat. No. 5,231,062 discloses the manufacture of a transparent aluminum magnesium oxynitride ceramic comprising more than 0.5 wt. % (preferably 4 to 9 wt. %) MgO, 11 to 16 wt. % AlN and Al₂O₃ as the balance. With respect to U.S. Pat. No. 5,231,062, magnesium oxide (MgO) is not slightly added but is rather used as an essential ingredient of the ceramic.

U.S. Pat. No. 7,045,091 teaches the manufacture of transparent aluminum oxynitride, which is characterized by sintering Al₂O₃ and AlN at a temperature of 1950° C. to 2025° C. (at which solid phase and liquid phase coexist) by the help of the liquid phase, and by resintering them at a temperature lower by at least 50° C. (at which only the solid phase exists) to change the liquid phase into the solid phase.

According to tests conducted by the inventors, however, there is a problem with transparent aluminum oxynitride crystals manufactured by the above-discussed prior art technology. This is because a great number of porosities exist therein, thereby lowering the transparency.

Further, most prior art technologies manufacture transparent aluminum oxynitride crystals in such a manner that an aluminum oxynitride powder is separately manufactured by the reaction of Al₂O₃ and AlN powder. They are then sintered once again. Accordingly, there is a problem in that the processes are complex and the manufacturing costs become high.

### DISCLOSURE

### Technical Problem

The present invention is directed to solving the foregoing problems of the prior art. It is an object of the present invention to provide a method of manufacturing a transparent aluminum oxynitride ceramic, wherein all porosities are eliminated in a sintered body.

It is a further object of the present invention to manufacture a transparent aluminum oxynitride ceramic using a simple process.

### Technical Solution

In order to achieve the above objects according to the present invention, a small amount of magnesium oxide (MgO) is added as a sintering additive (not as an essential ingredient of ceramic).

Further, presintering is performed at a relatively low temperature, thereby improving the sintering process.

The present invention will be described by way of concrete embodiments.

According to one embodiment of the present invention, a sintering additive is added to a source powder. They are then sintered to manufacture a transparent aluminum oxynitride. The sintering additive includes less than 0.5 wt. % MgO (preferably more than 0.05 wt. % and less than 0.3 wt. %, more preferably 0.1 wt. % to 0.2 wt. %).

According to experiments conducted by the inventors, the transparency of an aluminum oxynitride ceramic was remarkably enhanced when an appropriate small amount of MgO is used as the sintering additive, unlike the case where MgO is used at a high weight ratio. Thus, the role of MgO of the present invention is distinguished from that of MgO of a conventional ceramic based on aluminum oxynitride, wherein MgO is used as an essential ingredient.

To manufacture a translucent alumina, it is necessary that MgO is added as a sintering additive. However, it is not known that MgO also plays a similar role in sintering the aluminum oxynitride. It has been merely predicted that effects concerned with MgO, which occur in alumina, cannot be accomplished with regard to aluminum oxynitride. Indeed, according to the experiments conducted by the inventors, it could be ascertained that the sintering density is rather decreased when only MgO is added in manufacturing aluminum oxynitride without adding any Y₂O₃. Accordingly, it is believed that MgO of aluminum oxynitride plays a role different from the role that MgO of pure alumina plays as a sintering additive.

Further, the sintering additive may further include B, Y, La, compound of B, compound of Y or compound of La, which is known as a sintering additive for use with manufacturing aluminum oxynitride. Preferably, it may further include one or more of Y₂O₃ and BN at 0.5 wt. % and below. According to the experiments conducted by the inventors, it appeared that the transparency of aluminum oxynitride was remarkably enhanced when said known sintering additive and MgO were used together as the sintering additive.

According to a further embodiment of the present invention, a method of manufacturing a transparent aluminum oxynitride ceramic, comprises: presintering a source powder with a sintering additive added thereto at 1550° C. to 1750° C. so that a relative density becomes 95% or more; and resintering it at 1900° C. or more so that the higher relative density is accomplished.

The relative density, as used herein, means a ratio of relative value of relative density to theoretical density. Porosity is obtained by subtracting the relative density from 100. The relative density may be measured by an immersion method using Archimedes's principle.

Presintering is performed at 1550° C. to 1700° C., which is lower than resintering. This is because sintering is performed as fast as possible along with reaction into ALON phase since sintering is better performed at ALON phase rather than Al₂O₃ and AlN are mixed together. In case the temperature rises before a sufficient reaction, crystal grains become large and the reaction into ALON phase is retarded as much and the densification rate can be decreased thereby. Another reason that presintering is performed at 1550° C. to 1700° C., which is lower than resintering, is to eliminate as many porosities as possible at relatively low temperatures (at which crystal grain growth is minimal). Generally, sintering at higher temperatures makes it difficult to eliminate the porosities completely due to the growth of porosities accompanied by the crystal grain growth.

According to another embodiment of the present invention, Al₂O₃ and AlN powder are used as the source powder as they are. According to the present invention, sinterability is greatly enhanced. Accordingly, a high-density transparent aluminum oxynitride ceramic can be manufactured by directly mixing Al₂O₃ and AlN powder together with a sintering additive (instead of using aluminum oxynitride powder synthesized from Al₂O₃, AlN or the like as sintering materials similar to prior art technologies) and forming and sintering it.

### DESCRIPTION OF DRAWINGS

FIG. 1 is a photograph taken as aluminum oxynitride ceramic samples are arranged for purposes of comparing transparencies of the samples.

FIG. 2 is a graph showing linear transmittances of the samples, which are measured according to wavelengths.

FIGS. 3 to 6 are electron microscope photographs of the fracture surfaces of the samples.

FIG. 7 is a photograph taken as aluminum oxynitride ceramic samples are arranged for purposes of comparing transparencies of the samples.

FIG. 8 is a graph showing linear transmittances of the samples, which are measured according to wavelengths.

FIGS. 9 and 10 are electron microscope photographs of the fracture surfaces of the samples.

FIG. 11 is a photograph taken as aluminum oxynitride ceramic samples are arranged for purposes of comparing transparencies of the samples.

FIG. 12 is a graph showing linear transmittances of the samples, which are measured according to wavelengths.

FIG. 13 is a graph showing results on X-Ray Diffractometery (XRD) analysis of the samples.

FIGS. 14 to 21 are electron microscope photographs of the samples that are etched by phosphoric acid after surface grinding.

FIGS. 22 to 27 are electron microscope photographs of the samples with their surfaces grinded.

FIGS. 28 to 31 are electron microscope photographs of the fracture surfaces of the samples.

### BEST MODE

Examples, wherein an aluminum oxynitride ceramic is manufactured under various process conditions according to the present invention, will now be described with reference to the accompanying drawings.

### Example 1

Five aluminum oxynitride ceramic samples were fabricated under conditions where Y₂O₃ and BN (amounts of which are fixed at 0.08 wt. % and 0.02 wt. %, respectively) and MgO (amount of which is changed at 0, 0.05, 0.1, 0.2 and 0.3 wt. %) are added as a sintering additive to a source powder of Al₂O₃ and AlN (65:35 mole ratio). The mixed source powder and sintering additive are milled for 48 hours in a polyurethane container together with an ethyl alcohol solvent by means of high-purity Al₂O₃ balls and then were dried using a rotary evaporator. The dried powder was formed into a disk of 20 mm diameter and 3 mm width using a uniaxial dry press and it was then cold isostatic pressed. The disk sample was put in a graphite crucible and was sintered under nitrogen gas atmosphere of 1 atmospheric pressure in a high-temperature electric furnace with graphite heating elements. Then, it was maintained for 10 hours at 1675° C. and for 5 hours at 2000° C. The temperature-rising rate was 20° C. per minute up to 1500° C. and was 10° C. per minute at more than 1500° C. A cooling rate was 20° C. per minute.

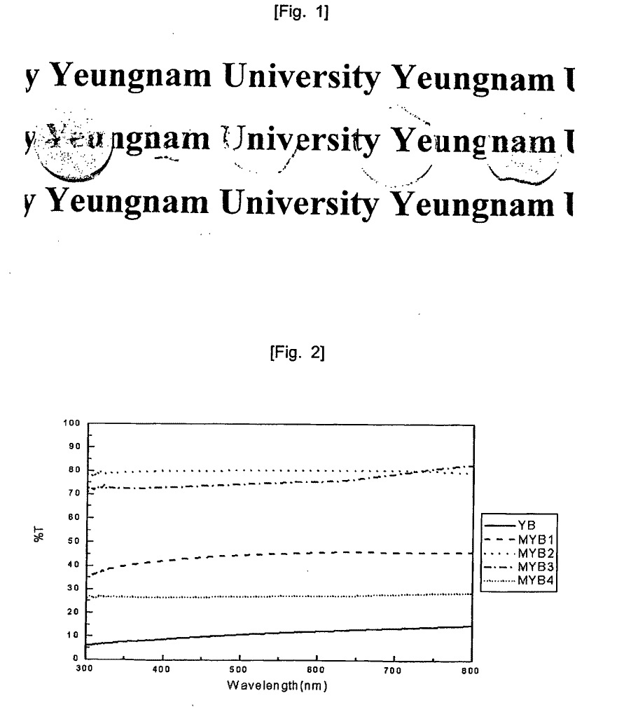

FIG. 1 is a photograph taken as aluminum oxynitride ceramic samples fabricated as such are so arranged that their transparencies are compared. The addition amounts of MgO in the samples were 0, 0.05, 0.1, 0.2 and 0.3 wt. %, respectively, from left to right. In case of no addition of MgO, the transparency was very low. In case of addition of 0.05 wt. % MgO, the transparency was greatly enhanced. In case of addition of 0.1 wt. % or 0.2 wt. % MgO, the transparency became very high. Further addition rather reduced the transparency.

FIG. 2 is a graph showing linear transmittances of the samples, which are measured according to wavelengths. MgO composition of each sample is shown in Table 1 provided below. The linear transmittance was measured at each sample in a wavelength range of 0.3 μm to 0.8 μm by using a Varian Spectrophotometer (Carry 500) after each sintered sample was surface-grinded by a diamond paste of 1 mm. In such a case, the width of the sample was 1.9 mm. Every “linear transmittance” as mentioned in the specification was measured in the above-described manner.

TABLE 1

| | YB | MYB-1 | MYB-2 | MYB-3 | MYB-4 |
|---|---|---|---|---|---|
| MgO | 0 | 0.05 | 0.1 | 0.2 | 0.3 |
| Transmittance | 11.38 | 44.12 | 79.89 | 76.77 | 27.47 |
| (Average) | | | | | |

Table 1 shows an average linear transmittance of each sample, which has a different addition amount of MgO. The average linear transmittance of the sample with 0.1 wt. % MgO added thereto was high as 79.89%.

The linear transmittance means a value obtained without taking account of the surface reflection (function of a refractive index) from a substantial transmittance. For example, in case of aluminum oxynitride with a refractive index of 1.79, a theoretical linear transmittance can be obtained up to 82%. Also, when a surface reflection is eliminated by Anti-Reflection (AR) coating, a substantial transmittance close to 100% is obtained. Thus, where such surface reflection is considered, the substantial transmittance in the case of addition of 0.1 wt. % MgO is (79.89/82) %. If surface reflection error is taken into account, then it is more than 95%.

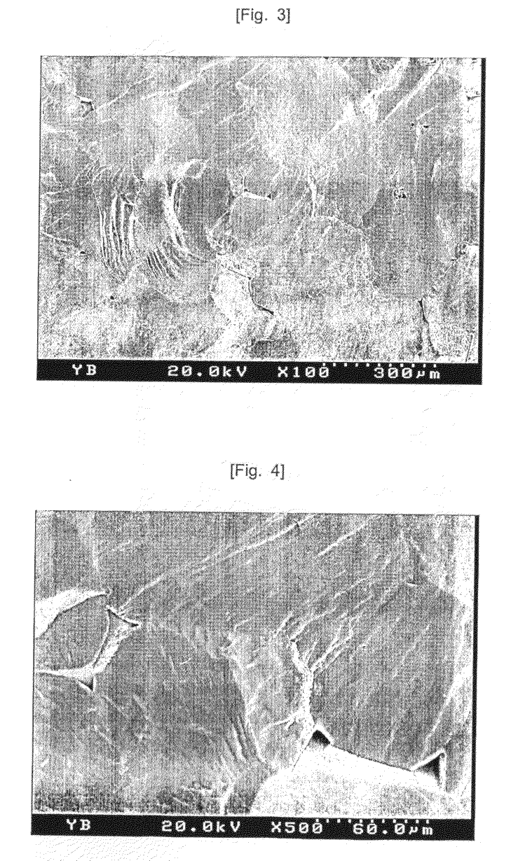

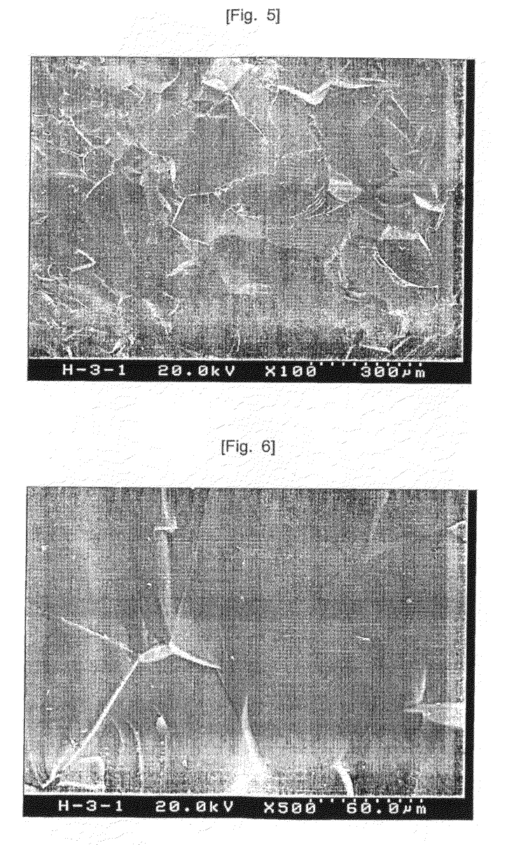

FIGS. 3 to 6 are electron microscope photographs of fracture surfaces of the fabricated samples. A numerical value (e.g., 300 μm, 60 μm), which is seen at a lower right side of each photograph, represents a length corresponding to summed up 10 scales, which are seen above each numerical value in each photograph. Further, the magnification of the electro microscope (e.g., ×100, ×500) is seen at a left side of the numerical value. The above-mentioned matters are equally applied to other drawings. Referring to FIGS. 3 and 4, which are the electron microscope photographs of the cases where only 0.08 wt. % Y₂O₃ and 0.02 wt. % BN were used as the sintering additive without any MgO, the ×500 magnification electron microscope photograph of FIG. 4 shows porosities such as two porosities at lower right side thereof. Further, the ×100 magnification electron microscope photograph of FIG. 3 shows large porosities such as several porosities at a slightly lower side apart from a center thereof. These porosities lowered the transparency. However, referring to FIGS. 5 and 6, which are the electron microscope photographs of the fracture surface of the sample wherein 0.1 wt. % MgO was added together with 0.08 wt. % Y₂O₃ and 0.02 wt. % BN, porosities are not nearly observed and the transparency is also very high.

### Example 2

Aluminum oxynitride ceramic samples were fabricated by using the same method as in example 1 except that the sintering additive of 0.2 wt. % MgO, 0.08 wt. % Y₂O₃ and 0.02 wt. % BN was differently added to each sample in the following manner: (1) no addition; (2) addition of MgO and Y₂O₃; (3) addition of MgO and BN; (4) addition of Y₂O₃ and BN; and (5) addition of MgO, Y₂O₃ and BN.

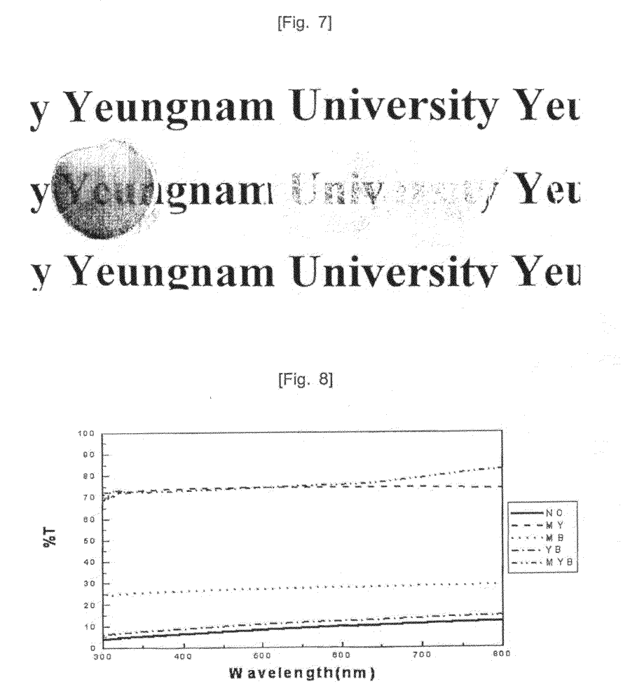

FIG. 7 is a photograph taken for purposes of comparing the transparencies of such fabricated aluminum oxynitride ceramic samples. (1) The sample without no addition of the sintering additives, (2) the sample with MgO and Y₂O₃ added thereto, (3) the sample with MgO and BN added thereto, (4) the sample with Y₂O₃ and BN added thereto, and (5) the sample with all of MgO, Y₂O₃ and BN added thereto are seen in said photograph from left to right. In case of no addition of MgO, the transparency was very low. In case of addition of MgO together with Y₂O₃ or MgO together with Y₂O₃ and BN, the transparency was very high. Among the sintering additive, MgO greatly contributed to the transparency. FIG. 8 is a graph showing the linear transmittances of the samples, which are measured according to wavelengths. Table 2 shows the composition and average linear transmittance of each sample.

TABLE 2

| | MgO | Y₂O₃ | BN | Transmittance |
|---|---|---|---|---|
| | (0.2 wt %) | (0.08 wt %) | (0.02 wt %) | (Average) |
| NO | X | X | X | 9.36 |
| MY | ◯ | ◯ | X | 73.77 |
| YB | X | ◯ | ◯ | 11.68 |
| MB | ◯ | X | ◯ | 27.42 |
| MYB | ◯ | ◯ | ◯ | 76.77 |

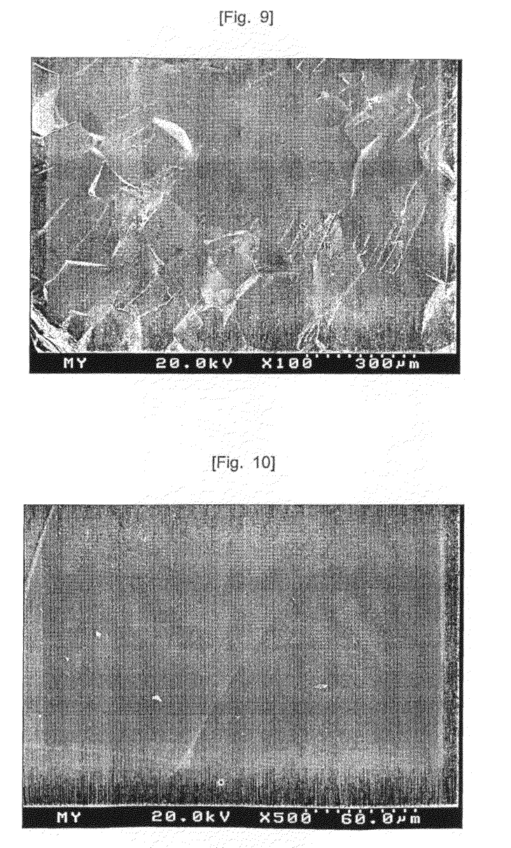

FIGS. 9 and 10 are electron microscope photographs of the fracture surfaces of the sample with MgO and Y₂O₃ added thereto. It can be seen in the sample in the electron microscope photographs of FIGS. 9 and 10 that all porosities were nearly eliminated and the transparencies became high when compared to the electron microscope photographs of the fracture surface of the sample with Y₂O₃ and BN added thereto shown in FIGS. 3 and 4 of example 1.

### Example 3

Aluminum oxynitride ceramic samples were fabricated by using the same method as in example 1 except sintering the samples for 5 hours at 2000° C. without presintering them. Addition amounts of MgO to each sample were at 0, 0.05, 0.1, 0.2 and 0.3 wt. %, respectively.

FIG. 11 is a photograph taken so that the transparencies of so fabricated aluminum oxynitride ceramic samples can be compared. In FIG. 11, the samples with MgO added thereto at 0, 0.05, 0.1, 0.2 and 0.3 wt. %, respectively, are arranged from left to right.

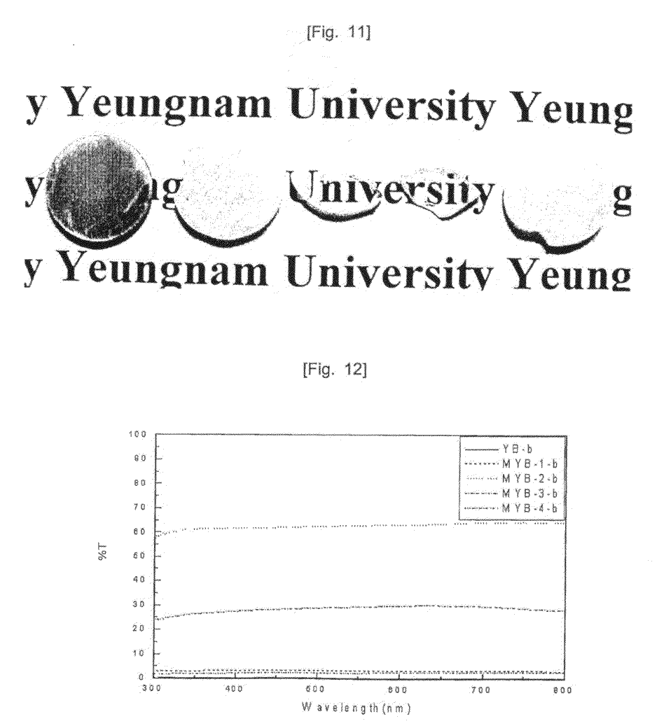

FIG. 12 is a graph showing measured values of the linear transmittance of each sample according to wavelengths. Table 3 shows the weight ratio of MgO and the average linear transmittance of such samples.

TABLE 3

| | YB-b | MYB-1-b | MYB-2-b | MYB-3-b | MYB-4-b |
|---|---|---|---|---|---|
| MgO(wt %) | 0 | 0.05 | 0.1 | 0.2 | 0.3 |
| Transmittance | 0.2 | 3.24 | 63.11 | 28.73 | 2.46 |
| (Average) | | | | | |

Similar to example 1, in case of addition of 0.1 wt. % MgO, the transparency was highest. However, the transparency was lowered by approximately 20% when compared to the sample with MgO added thereto at 0.1 wt. % of example 1, wherein presintering was performed. In this example without any presintering, the transparency was nearly lost in the cases of addition of 0 wt. %, 0.05 wt. % or 0.3 wt. % MgO. Further, whether presintering is performed or not had a greater influence on the transparency in the case of addition of 0.2 wt. % MgO than the case of addition of 0.1 wt. % MgO. In such an example, the transparency was lowered due to influences resulting from a plurality of porosities. Further, presintering had a great influence on the transparencies of the sintered samples irrespective of the presence or absence of MgO.

### Example 4

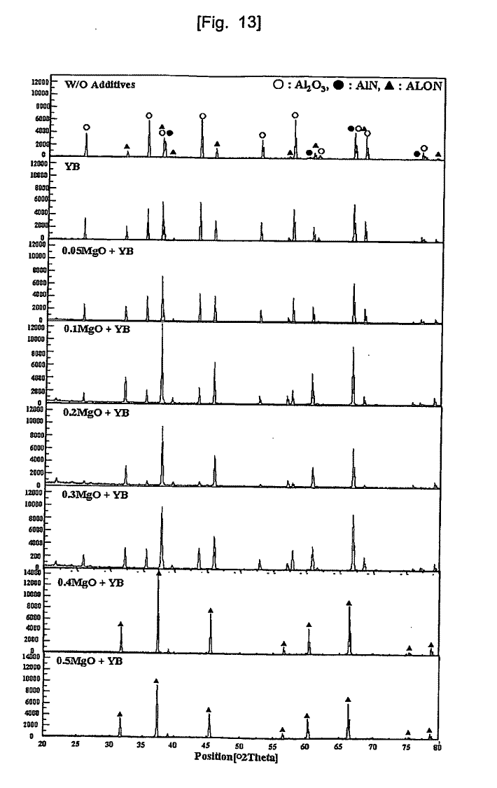

A sample with any sintering additive not added to Al₂O₃ and AlN powder, a sample with only 0.08 wt. % Y₂O₃ and 0.02 wt. % BN added as sintering additives, and aluminum oxynitride ceramic samples with 0.05 wt. %, 0.1 wt. %, 0.2 wt. %, 0.3 wt. %, 0.4 wt. % and 0.5 wt. % MgO added respectively thereto together with 0.08 wt. % Y₂O₃ and 0.02 wt. % BN were fabricated using the same method as in example 1, except that the samples were only presintered for 10 hours at 1675° C. A graph showing results on X-Ray Diffractometery (XRD) analysis of said eight samples is shown in FIG. 13 from top to down one after the other.

Referring to the graph of FIG. 13, peaks of not yet reacting Al₂O₃ and AlN appeared relatively high and a peak of aluminum oxynitride (ALON) appeared low in the samples without any MgO added thereto. On the contrary, as MgO was added more and more, the peaks of Al₂O₃ and AlN became low and the peak of aluminum oxynitride became high. The samples with 0.4 wt. % and 0.5 wt. % MgO respectively added thereto showed only the peak of aluminum oxynitride. Thus, it could be seen from such samples that all Al₂O₃ and AlN reacted into aluminum oxynitride.

When MgO was used together with Y₂O₃ and BN as the sintering additive, the reaction of Al₂O₃ and AlN into aluminum oxynitride was promoted. As described above, sintering was better performed at aluminum oxynitride phase of Al₂O₃ and AlN than they were mixed.

A small amount of MgO can promote the densification of aluminum oxynitride more or less similarly to the case where it is added to alumina. Thus, it is advantageous that the residual porosities becoming a little bit small as such can be completely eliminated by high-temperature sintering for a long time. According to the experiments conducted by the inventors, however, adding only MgO without adding Y₂O₃ and BN rather greatly reduced the sintering density. In other words, when considering that only adding MgO together with Y₂O₃ and BN gives great help to eliminating the porosities, it is believed that MgO of aluminum oxynitride plays a role different from a role of sintering promoter, which MgO of pure alumina plays.

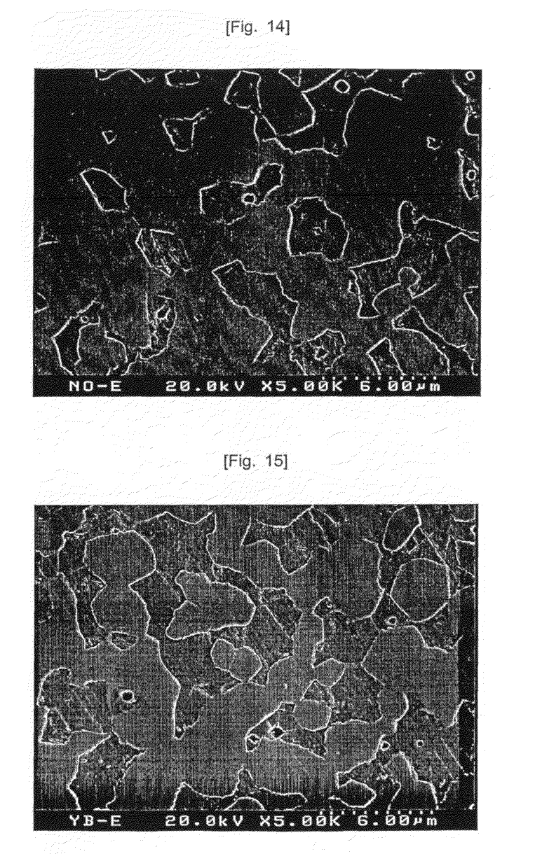

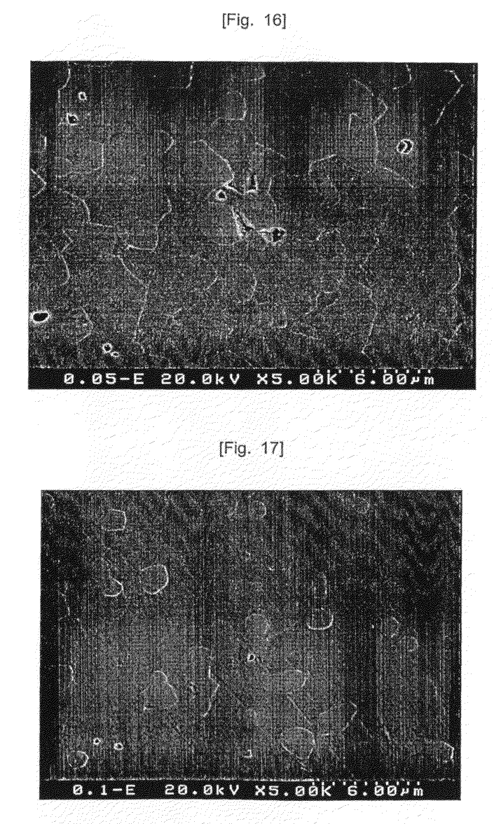

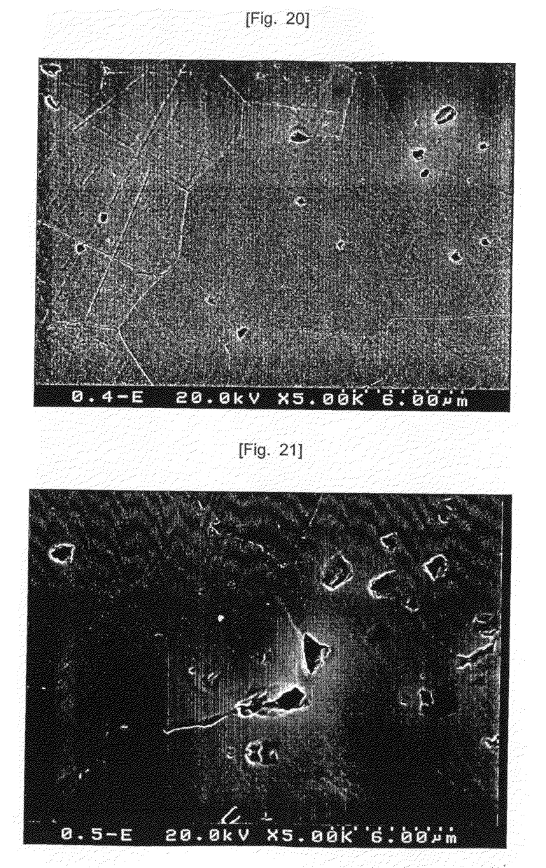

The sample with any sintering additives not added to Al₂O₃ and AlN powder, the sample with only 0.08 wt. % Y₂O₃ and 0.02 wt. % BN added as sintering additives, and the aluminum oxynitride ceramic samples with 0.05 wt. %, 0.1 wt. %, 0.2 wt. %, 0.3 wt. %, 0.4 wt. % and 0.5 wt. % MgO added thereto together with 0.08 wt. % Y₂O₃ and 0.02 wt. % BN (all the samples were subjected to only presintering for 10 hours) were surface-grinded and were etched by phosphoric acid. Then, their photographs were taken through an electron microscope. FIGS. 14 to 21 sequentially show such photographs.

Elementary analysis of oxygen and nitrogen using an Energy Dispersive Spectroscopy (EDS) showed that protruding and relatively bright crystal phases were not yet reacting Al₂O₃, and that much etched and relatively dark phases were AlN and ALON phase. The amounts of Al₂O₃, AlN and ALON phase in the samples were accurately accorded with the XRD analysis result.

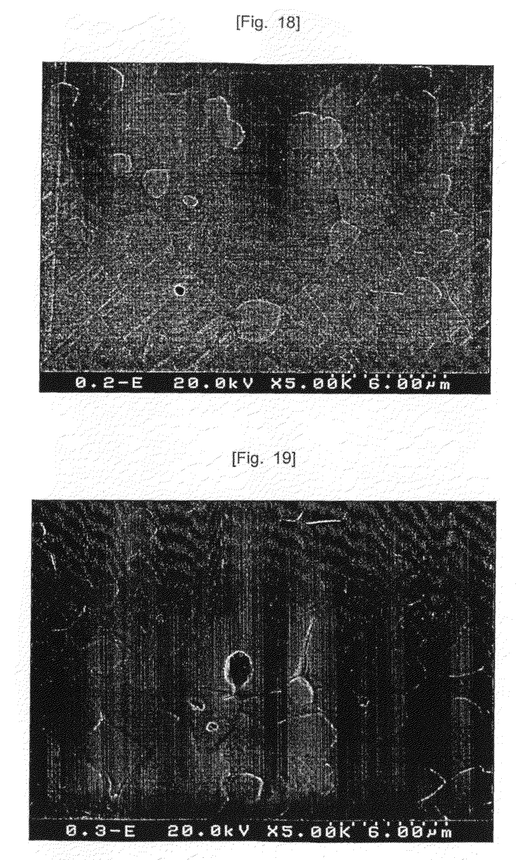

When 0.1 wt. % or 0.2 wt. % MgO was added (FIG. 17, FIG. 18), the size of the porosities was remarkably small and the amount thereof was also very small. However, when more than 0.3 wt. % MgO was added (FIGS. 19 to 21), it could be ascertained that the size and amount of the porosities were rather increased gradually.

### Example 5

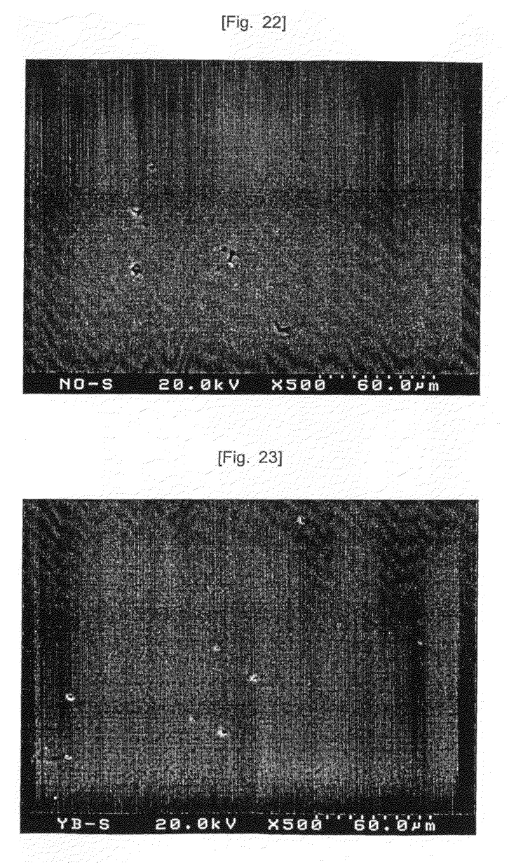

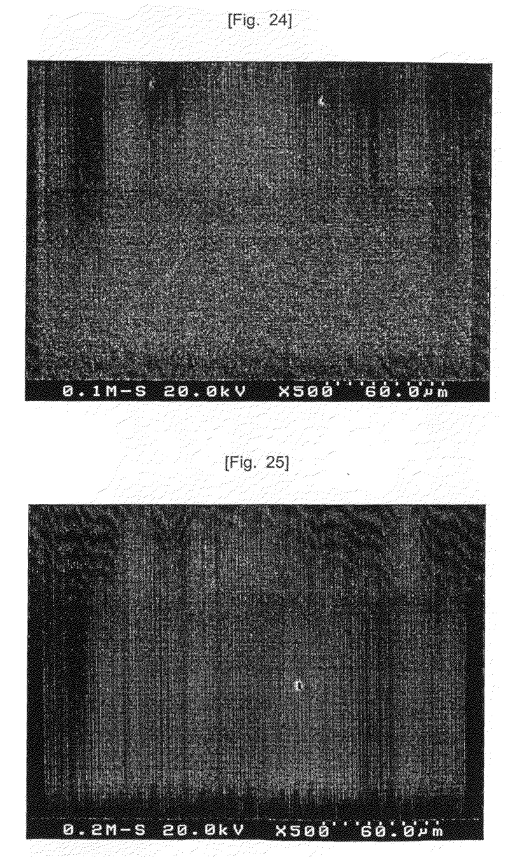

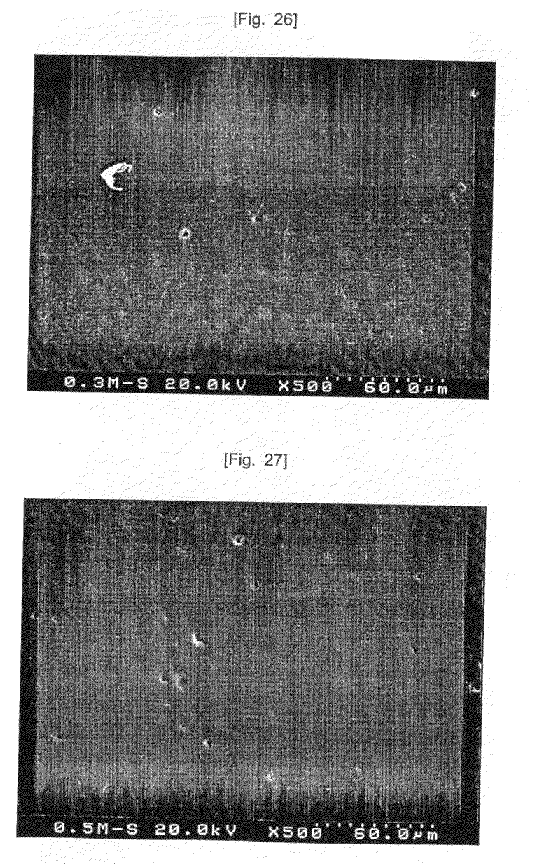

A sample with any sintering additives not added to Al₂O₃ and AlN powder, a sample with only 0.08 wt. % Y₂O₃ and 0.02 wt. % BN added as a sintering additive, and aluminum oxynitride ceramic samples with 0.05 wt. %, 0.1 wt. %, 0.2 wt. %, 0.3 wt. %, 0.4 wt. % and 0.5 wt. % MgO added respectively thereto together with 0.08 wt. % Y₂O₃ and 0.02 wt. % BN were fabricated using the same method as in example 4. Photographs taken through an electron microscope after surface-grinding said samples are sequentially shown in FIGS. 22 to 27. The size and amount of porosities of each sample can be compared by comparing FIGS. 22 to 27 with each other. When 0.1 wt. % or 0.2 wt. % MgO was added (FIG. 24, FIG. 25), the size of the porosities was remarkably small and the amount thereof was also very small. However, when more than 0.3 wt. % MgO was added (FIG. 26 and FIG. 27), it could be ascertained that the size and amount of the porosities were rather increased gradually.

### Example 6

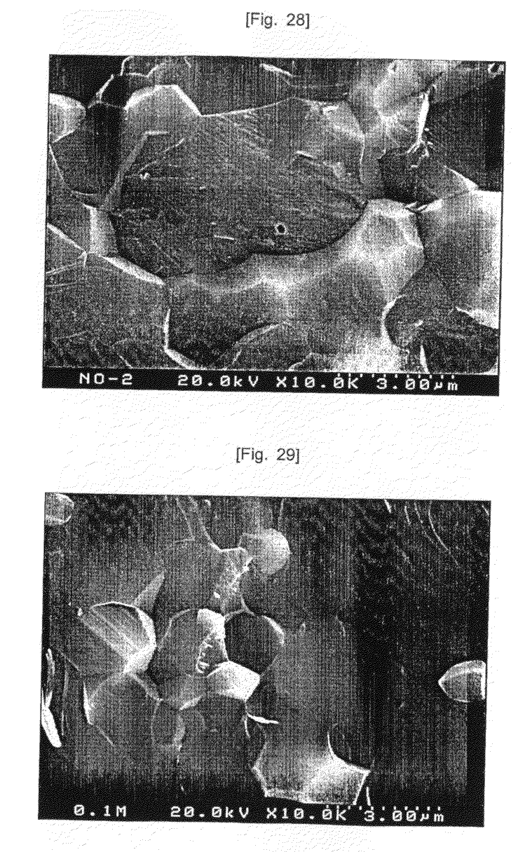

A sample with any sintering additives not added to Al₂O₃ and AlN powder, and aluminum oxynitride ceramic samples with 0.1 wt. %, 0.4 wt. % and 0.5 wt. % MgO added respectively thereto together with 0.08 wt. % Y₂O₃ and 0.02 wt. % BN were fabricated using the same method as in example 4. FIGS. 28 to 31 are electron microscope photographs of the fracture surfaces of said samples.

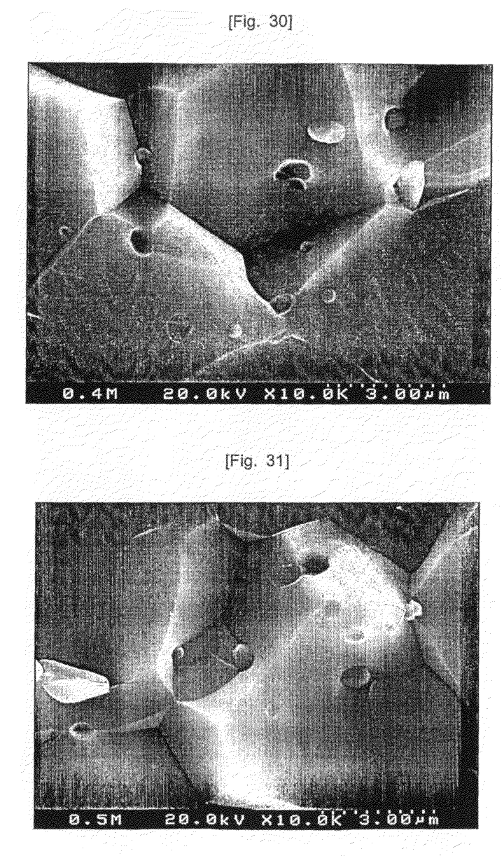

Referring to FIGS. 30 and 31, secondary phases having a size of 0.5 μm were shown in the samples with 0.4 wt. % and 0.5 wt. % MgO added thereto. Those are believed to be Mg-spinel phases, which are created when the added amount of MgO exceeds solid solubility content of aluminum oxynitride. Those secondary phases can hinder densification during sintering (i.e., elimination of porosities).

According to results of above-described examples 4 to 6, adding appropriate amount of MgO promotes reaction of Al₂O₃ and AlN into aluminum oxynitride and thus allows reaction sintering at relatively low temperatures, thereby allowing porosities to be stably eliminated. However, excessively adding MgO creates secondary phases and hinders sintering, thereby making it difficult to eliminate the porosities. That is, adding an appropriate amount of less than 0.5 wt. % MgO helps to maximally eliminate the porosities inside aluminum oxynitride, thereby greatly enhancing the transparency of aluminum oxynitride.

### INDUSTRIAL APPLICABILITY

As described above, according to the present invention, there is provided a cubic-phased polycrystalline aluminum oxynitride ceramic, wherein porosities therein are nearly eliminated and its substantial transparency becomes 95% or more.

In particular, since such transparent cubic-phased polycrystalline aluminum oxynitride ceramic has high strength and hardness as well as abrasion resistance, it can be diversely utilized to products such as a transparent bulletproof plate, a window of an infrared sensor, a radar dome, etc., which requires high strength, hardness and abrasion resistance in addition to transparency.

Further, according to a sintering additive and sintering process of the present invention, sinterability is enhanced. Thus, although Al₂O₃ and AlN powder are mixed and sintered, a transparent aluminum oxynitride ceramic can be fabricated, thereby simplifying the manufacturing process and reducing the processing costs.

1-10. (canceled)

11. A method of manufacturing a transparent polycrystalline aluminum oxynitride ceramic, comprising:
combining a source powder and a sintering additive, wherein the sintering additive includes less than 0.5% by weight of MgO.

12. The method of claim 11, wherein the sintering additive further includes less than or equal to 0.5% by weight of Y₂O₃.

13. The method of claim 12, wherein the sintering additive includes between 0.05% by weight and 0.3% by weight of MgO.

14. A method of manufacturing a transparent polycrystalline aluminum oxynitride ceramic, comprising:
presintering a mixture comprising a source powder and a sintering additive at a temperature from 1550° C. to 1750° C. to produce a sintered product having a relative density of 95% or more; and
resintering the sintered product at a temperature of 1900° C. or more to produce a resintered product having a relative density higher than that of the sintered product.

15. A method of manufacturing a transparent polycrystalline aluminum oxynitride ceramic comprising:
combining a source powder and a sintering additive that includes less than 0.5% by weight of MgO;
presintering the source powder at a temperature of 1550° C. to 1750° C. to produce a sintered product having a relative density of 95% or more; and
resintering the sintered product at a temperature of 1900° C. or more to produce a resintered product having a relative density higher than that of the sintered product.

16. The method of claim 15, wherein the source powder is a mixture comprising Al₂O₃ and AlN powder.

17. The method of claim 16, wherein the sintering additive comprises a mixture of 0.08% by weight of Y₂O₃, 0.02% by weight of BN, and 0.1% by weight of MgO.

18. The method of claim 17, wherein presintering is performed for 10 hours at 1675° C. under a nitrogen gas atmosphere, and
wherein resintering is performed for 5 hours at 2000° C. under a nitrogen gas atmosphere.

19. The method of claim 15, wherein the sintering additive further includes less than or equal to 0.5% by weight of Y₂O₃.

20. The method of claim 15, wherein the sintering additive includes between 0.05% by weight and 0.3% by weight of MgO.
